(19) United States
(12) Patent Application Publication
(10) Pub. No.: US 2015/0104590 A1
(43) Pub. Date: Apr. 16, 2015

(54) Method For Marking A Metal Substrate By Means Of The Incorporation Of Inorganic Luminescent Particles

(71) Applicant: COMMISSARIAT A L'ENERGIE ATOMIQUE ET AUX ENERGIES ALTERNATIVES, Paris (FR)

(72) Inventors: Nicolas Charvet, Voreppe (FR); Stéphanie Desrousseaux, Grenoble (FR); Bruno Laguitton, Grenoble (FR); Sakina Yahiaoui, Vizille (FR)

(21) Appl. No.: 14/579,813

(22) Filed: Dec. 22, 2014

Related U.S. Application Data
(63) Continuation of application No. PCT/FR2013/051730, filed on Jul. 17, 2013.

(30) Foreign Application Priority Data
Jul. 25, 2012 (FR) 1257191

(51) Int. Cl. G07C 11/00; C23C 22/82; C09K 11/02; B44F 1/10; C09K 11/77; C23C 22/06; C25D 11/24

(52) U.S. Cl. CPC G07C 11/00; C23C 22/06; C23C 22/82; C25D 11/24; B44F 1/10; C09K 11/7794; C09K 11/025
USPC 428/29; 148/276; 205/118

(57) ABSTRACT

passivation layer by oxidation of the surface of the metal substrate; incorporating inorganic luminescent particles within the metal substrate passivation layer, the average particle size being in the range from 4 to 1,000 nm; and clogging the passivation layer.

### FIELD OF THE INVENTION

The present invention relates to a method of marking a metal substrate by integrating luminescent particles within the metal substrate passivation layer.

Thus, the optical detection of the integrated luminescent particles enables to authenticate and to trace a metal substrate, particularly in the context of the fight against counterfeiting.

### BACKGROUND OF THE INVENTION

Different substrate marking methods have been described in prior art. They particularly include, in the field of object decoration, incorporating organic dyes. Such methods enable to decorate plastic, paper, or metal objects.

Pigments may also for example be incorporated within the passivation layer of aluminum objects. However, all the disclosed processes concern the forming of a mark visible to the naked eye, mainly with the purpose of decorating an object.

There thus is a need to develop new marking methods making objects traceable and identifiable by means of specific techniques, to thus facilitate the fight against counterfeiting.

The Applicant has developed a new method enabling to incorporate luminescent particles, the presence of which can be detected by spectrophotometry.

### SUMMARY OF THE INVENTION

The present invention aims at a method enabling to mark a substrate by means of luminescent particles, particularly of submicron particles. The substrate thus marked is identifiable only at the wavelengths at which the particles emit or absorb. Accordingly, in normal conditions of use, the marker is not visible to the naked eye and thus does not alter the visual aspect of the substrate. This technique can thus enable to make out a counterfeited object from a non-counterfeited object.

The luminescent marker can be detected by means of an appropriate detector recognizing the luminescence signature, thus providing a traceability and authentication method. The marker is only revealed under non-visible light, of UV, IR, or near IR type.

More specifically, the present invention relates to a method of marking a metal substrate, comprising the steps of:
forming a passivation layer by oxidation of the surface of the metal substrate;
incorporating inorganic luminescent particles within the metal substrate passivation layer;
clogging the passivation layer.

Before the implementation of the first steps of this method, the metal substrate may also be pretreated in a concentrated base solution (NaOH, KOH . . . ), possibly oxidizing, or little oxidizing (carbonate, silicate). Such a pretreatment enables to perform a cleaning of the surface to be treated to remove impurities (coloring, grease) as well as the natural passivation layer normally insufficient to provide good anti-corrosion properties.

The metal substrate is made of anodizable materials, that is, materials having at least their upper layer capable of being oxidized. The passivation layer designates this oxidation layer.

Generally, the metal substrate is a material capable of forming a porous oxide layer at the surface. It may advantageously be selected from the group comprising stainless steels; tin; zinc; titanium; aluminum and wrought alloys thereof (1000 to 8000 series capable of containing Si, Fe, Cu, Mn, Mg, Cr, Ni, Zn, or Ti atoms) or casting alloys thereof (20000, 40000, 50000, and 70000 series capable of containing B, Cr, Sn, Co, Ni, Ti, Cu, Mn, Mg, Si, Zn atoms); and mixtures thereof.

The metal substrate is advantageously made of aluminum, or of an aluminum-based alloy.

According to a specific embodiment, the anodizing (oxidation) step may be carried out under a DC, AC, or pulsed current, in particular when the substrate is made of aluminum or of an aluminum-based alloy. The electrolyte baths may create a porous oxide layer like sulphuric, chromic, boric-sulphuric phosphoric anodizing or also self-colored anodizing or also alkaline anodizing. The porous layer has variable thicknesses (up to some hundred micrometers) according to the anodizing parameters, such as the electrolyte concentration, temperature, current density, and chemical additives.

The oxidation step may be alternately carried out by immersion of the metal substrate in a strong acid solution, preferably an aqueous solution comprising at least one of the components selected from the group comprising HCl, HNO₃, H₂SO₄, or mixtures thereof. In this case, in addition to the creation of the porous layer, a cleaning of the substrate surface is simultaneously carried out.

The clogging is the step which enables to close the pores of the porous layer and thus provide the corrosion-resistance properties. Many processes exist for aluminum. Generally, such processes use water in liquid form or in vapor form. Accordingly, they may be carried out at different temperatures. Further, the addition of additives enables to modify the pore closing kinetics.

The inorganic luminescent particles may be advantageously selected from the group comprising particles based on, and advantageously made of, metal oxide; metal sesquioxide; metal oxyfluoride; metal vanadate; metal fluoride, and mixtures thereof.

They may also be particles selected from the group comprising Y₂O₃; YVO₄; Gd₂O₃; Gd₂O₂S; LaF₃; and mixtures thereof.

The particles are advantageously doped with one or a plurality of active sites from the lanthanide family or from the family of transition elements.

Further, inorganic luminescent particles may be used in mixtures to create a luminescent optical code.

Advantageously, the inorganic luminescent particles are doped with ions from the lanthanide family, advantageously europium. The intensity of the luminescence depends on the doping rate and may transit through a maximum. Thus, the doping of these particles may vary from 0.5 to 50% with respect to the number of metal moles forming the particles, more advantageously from 1 to 5%.

A plurality of markers, that is, a plurality of luminescent particles, may be used to mark the substrate. In this case, the quantity of each type of incorporated particles may be different. Further, each type of particles may have its own signature. In other words, the substrate authentication may require detecting a plurality of particles at different wavelengths.

Thus, by varying the proportion of each of the different markers, a plurality of optical codes may be created in view of the relative intensity of the luminescent signals.

According to a specific embodiment, the particles may comprise, within a same particle, different optical signatures detectable at different wavelengths. They then are diptych or triptych particles, for example.

Using inorganic particles is particularly advantageous due to their greater resistance to photobleaching phenomena which degrade the luminescence of organic markers. Further, the marking solutions implemented in this method have a lifetime greater than those containing organic markers.

Generally, the particles may have a spherical, cubic, cylindrical, parallelepipedal shape.

The size of the particles is defined by their greatest average dimension, that is, by their diameter when they have a spherical shape, their average length when they are in the shape of rods.

Thus, in the context of the invention, the luminescent particles are particles having an average size advantageously in the range from 4 to 1,000 nanometers.

According to a preferred embodiment, the particles are nanoparticles.

The average nanoparticle size advantageously is in the range from 4 to 100 nanometers, more advantageously still from 20 to 50 nanometers.

Further, the particles, and more advantageously the nanoparticles, may be encapsulated (coated), particularly in the polysiloxane or silicon oxide matrix. The new polysiloxane or silica surface can then be functionalized with organosilane coupling agents, such as substituted alkoxysilanes like aminopropyltriethoxysilane or derivatives of the same family. The forming of the polysiloxane surface or the functionalizing of this surface enables to improve the dispersion in the solvent and the particle stability in dispersions. Further, such surface modifications of the particles may affect the hydrophilic/hydrophobic character of the particles and thus modify the affinity and the diffusivity of the inorganic luminescent particles within the passivation layer. A better homogeneity of the luminescent particle distribution can thus be obtained.

When the particles are coated, their average size also remains within the above-mentioned size ranges. Generally, the coating increases the average particle size by in the order of from 5 to 15 nanometers.

The possible submicron dimension of the nanoparticles particularly enables to facilitate their incorporation in the passivation layer of the metal substrate.

This step concerning the incorporation of particles within the metal substrate may advantageously be carried out by dipping the substrate into a colloidal suspension of inorganic luminescent particles.

The metal substrate may be immersed, dipped, for a time period advantageously in the range from 5 to 120 minutes into the colloidal suspension, more advantageously still from 10 to 60 minutes.

During this step, the colloidal suspension is preferably at a temperature in the range from 90 to 100° C., more advantageously still from 96 to 99° C.

Generally, the colloidal suspension has a particle concentration which may be in the range from 0.01 to 10 g/L, more advantageously from 0.01 to 1 g/L.

Further, the colloidal suspension advantageously is a suspension of at least one type of inorganic luminescent particles in an organic and/or aqueous liquid.

Advantageously, it is a suspension in an aqueous medium advantageously comprising at least 90% of water by volume for at most 10% of an organic solvent miscible with water, such as for example an alcohol (glycol, propanol).

Preferably still, it is a suspension in a liquid made of 100% of water.

The colloidal suspension may also comprise an additive selected from the group comprising surface active agents, dispersant agents, and mixtures thereof.

The luminescent marker is incorporated by diffusion in the passivation layer of the metal substrate, after anodizing (oxidation) while the porosity of the passivation layer is open. Only at the clogging step does the passivation layer close and immobilize the particles.

The marker is thus trapped in the passivation layer of the metal substrate and cannot be removed without for the passivation layer to be destroyed.

According to a specific embodiment, the step of incorporating luminescent particles may be implemented in dyeing baths (organic or inorganic dyes) generally used in methods of anticorrosion treatment of metal substrates, such as aluminum parts, for example.

Thus, according to this embodiment, the implemented marking does not modify the metal substrate manufacturing methods.

Generally, the step of clogging the passivation layer is advantageously carried out simultaneously to the inorganic luminescent particle incorporation step.

A plurality of clogging baths may also be used. While the first clogging bath corresponds to the bath used to incorporate the particles, the secondary clogging baths may be deprived of particles. One may particularly use a water bath at a temperature in the range from 30 to 99° C. The substrate may thus be dipped from 10 to 60 minutes in the secondary clogging baths.

After the clogging step, the metal substrate is dried. It may also be rinsed with water at room temperature before being dried.

Further, according to another specific embodiment, the surface of the marker, that is, of the particles, may be functionalized to improve the chemical affinity with the passivation layer and thus decrease the desorption of the marker during the immersion in the clogging bath.

The present invention also aims at the metal substrate capable of being obtained according to the above-described method.

The invention and the resulting advantages will better appear from the following examples, provided as a non-limiting illustration of the invention.

### DETAILED DESCRIPTION OF THE INVENTION

For the examples described hereafter, the marker solutions used are aqueous suspensions of mixed europium-doped yttrium vanadate nanoparticles (5%) (5% mol substitution of yttrium ions). According to examples, the nanoparticles may be encapsulated or not by a polysiloxane or silicon oxide layer. The concentration of the nanoparticle suspensions used is 0.01; 0.1 or 1 g/L in (YVO₄: Eu) in water. The nanoparticles in this example have a quasi-spherical shape and have a diameter of 20 nanometers for non-coated nanoparticles, and of 30 nanometers for coated nano-particles.

The acid solution used to oxidize the metal substrate is made of a concentrated 2/1 v/v HCl/HNO₃ mixture.

The metal substrate used is an aluminum strip having a 5-mm width, a 3-cm length, and a 0.08-mm thickness.

A/Influence of the Oxidation Step

### EXAMPLE 1

An aluminum strip is dipped into the acid solution. After from 10 to 30 seconds and after gassing, the strip is rinsed by means of MQ water (MilliQ resistivity >18 MΩ) and dipped into the nanoparticle solution for a time period in the range from 30 minutes to 1 hour, at room temperature.

A luminescent deposit after drying is present on the entire strip but the coverage is not homogeneous.

In the following examples, the concentration of nanoparticles (coated or not) in the suspensions is 1 g/L of YVO₄:Eu in water.

### COUNTEREXAMPLE 1

An aluminum strip is dipped into a suspension of nanoparticles at room temperature. On removal of the strip, the latter has drops of the nanoparticle suspension at its surface. The drops remain in the form of drops and do not “wet” the metal. After the rinsing step, the metal substrate no longer comprises luminescent nanoparticles.

### EXAMPLE 2

An aluminum strip is dipped into the acid solution. After from 10 to 30 seconds and after gassing, the strip is rinsed with MQ water and dipped for 30 minutes into the nanoparticle solution (YVO₄:Eu previously coated with a polysiloxane or silicon oxide layer) heated at 99° C. The strip is then drained and dried with air.

A strong luminescence is visible and the deposition after drying is abrasion-resistant. The abrasion tests have been performed by friction of the metal substrate with a cloth impregnated with water and/or ethanol, once the strip has cooled down.

### EXAMPLE 3

An aluminum strip is dipped into the acid solution. After from 10 to 30 seconds and after gassing, the strip is rinsed by means of MQ water and dipped for 30 minutes into the nanoparticle solution (non-coated YVO₄: Eu) heated at 99° C. The strip is drained and dried with air.

The luminescence is low or even non-existent.

TABLE 1
influence of the oxidation step

| | Nano- | Acid | Bath | | Resistance | |
|---|---|---|---|---|---|---|
| Example | particles | treatment | temperature | Luminescence | to abrasion | Observations |
| Example | Coated | Yes | Tamb | Yes | No | non-homogeneous |
| 1 | | | | | | np distribution |
| | Non- | Yes | Tamb | Yes | No | non-homogeneous |
| | coated | | | | | np distribution |
| Counter- | Coated | No | Tamb | No | | |
| example | Non- | No | Tamb | No | | |
| 1 | coated | | | | | |
| Example | Coated | Yes | 99° C. | Yes | Yes | non-homogeneous |
| 2 | | | | | | np distribution |
| Example | Non- | Yes | 99° C. | low | | non-homogeneous |
| 3 | coated | | | | | np distribution |

Tamb = Room temperature, 25° C.
np = nanoparticles

The abrasion resistance tests have been performed by friction of the metal substrate with a cloth impregnated with water and/or ethanol, once the strip has cooled down.

These examples show that it is necessary to treat the metal substrate by an oxidation step (acid treatment) and that it is advantageous to use nanoparticles coated with a polysiloxane or silicon oxide layer. Further, the clogging step is advantageously carried out at a temperature higher than the room temperature.

B/Influence of the Number of Clogging Baths

In the following examples, the concentration of nanoparticles (coated or not) in the suspensions is 1 g/L of YVO₄:Eu in water.

In the examples of table 2, an aluminum strip is dipped into the acid solution. After from 10 to 30 seconds and after gassing, the strip is rinsed by means of MQ water. It is then dipped into a first clogging solution, rinsed, and then, possibly, dipped into a second clogging solution. The nature of the clogging bath, the immersion time, and the bath temperature are indicated in table 2.

The luminescence and the coverage are observed after drying of the strips in free air.

TABLE 2
Influence of the number of clogging baths

| | Nano- | 1^{rst} | Temperature | 2^{nd} | Temperature | | |
|---|---|---|---|---|---|---|---|
| Example | Particles | clogging | Time | clogging | Time | Luminescence | Observations |
| Example 4 | Non- | Particles | Tamb | H₂O | 99° C. | No | |
| | coated | | 30 minutes | | 30 minutes | | |
| Example 5 | Non- | Particles | 99° C. | — | — | Yes, light | non-homogeneous |
| | coated | | 30 minutes | | | | np distribution |
| Example 6 | Non- | Particles | Tamb | — | — | No | |
| | coated | | 30 minutes | | | | |
| Counter- | | H₂O | 99° C. | — | — | No | |
| example 2 | | | 30 minutes | | | | |
| Example 7 | Coated | Particles | Tamb | H₂O | 99° C. | No | |
| | | | 30 minutes | | 30 minutes | | |
| Example 8 | Coated | Particles | 99° C. | — | — | Yes | non-homogeneous |
| | | | 30 minutes | | | | np distribution |
| Example 9 | Coated | Particles | Tamb | — | — | No | |
| | | | 30 minutes | | | | |
| Counter- | | H₂O | 99° C. | — | — | No | |
| example 3 | | | 30 minutes | | | | |

In the examples of table 3, the strips are successively dipped into a pre-clogging bath at 50° C. containing the nanoparticles, and then into a water bath at 99° C. The strips are rinsed or not between the two baths. Such a clogging method in two steps is currently implemented in prior art for the introduction of organic markers on treatment of the aluminum surface.

TABLE 3
Influence of the number of clogging baths

| | | 1^{rst} | Temperature | | 2^{nd} | Temperature | |
|---|---|---|---|---|---|---|---|
| Example | Nanoparticles | clogging | Time | Rinsing | clogging | Time | Luminescence |
| Example 16 | Coated | Particles | 50° C. | Yes | H₂O | 99° C. | No |
| | | | 30 minutes | | | 30 minutes | |
| Example 17 | Non-coated | Particles | 50° C. | Yes | H₂O | 99° C. | No |
| | | | 30 minutes | | | 30 minutes | |
| Counter- | Coated | Particles | 50° C. | No | H₂O | 99° C. | No |
| example 7 | | | 30 minutes | | | 30 minutes | |
| Counter- | Non-coated | Particles | 50° C. | No | H₂O | 99° C. | No |
| example 8 | | | 30 minutes | | | 30 minutes | |

Unlike prior art organic dyes, the operating mode comprising using a pre-clogging bath containing the markers does not seem to be adapted to nanoparticles. The markers are in all likelihood released back during the final hot clogging.

C/Influence of the Time of Immersion in the Clogging Bath

The time necessary to carry out the clogging of an aluminum substrate is generally in the order of 2 min/micrometer of oxide.

For the above-detailed examples, the nanoparticle concentrations are 1 g/L and the temperature of the clogging bath is set to 99° C. The nanoparticles used are coated or not with a polysiloxane layer.

For each of the examples of table 4, two strips are treated, one is rinsed with distilled water just after coming out of the clogging bath and before it is dried (AR), the other being simply left to dry in the ambient air (SR).

TABLE 4
Influence of the time of immersion in the clogging bath

| | | Immersion | | |
|---|---|---|---|---|
| Example | Nanoparticles | time | Luminescence | Observations |
| Example | Non-coated | 10 minutes | AR: no | |
| 10 | | | SR: no | |
| Example | Coated | 10 minutes | AR: no | Luminescence visible on the area |
| 11 | | | SR: light | having undergone the acid treatment, |
| | | | | under UV illumination |
| Example | Non-coated | 30 minutes | AR: no | |
| 12 | | | SR: no | |
| Example | Coated | 30 minutes | AR: no | Luminescence visible on the area |
| 13 | | | SR: yes | having undergone the acid treatment, |
| | | | | under UV illumination |
| Example | Non-coated | 60 minutes | AR: no | |
| 14 | | | SR: light | |
| Example | Coated | 60 minutes | AR: no | Luminescence visible on the area |
| 15 | | | SR: yes | having undergone the acid treatment, |
| | | | | under UV illumination |

Conversely to examples 1 and 2 of table 1, the rinsing operations of the examples of table 4 are performed directly after the coming out of the clogging bath, that is, when the strip is still hot. Such a metal temperature, together with the drying time of the solutions, may explain the disparity between the two series of manipulations.

These examples show the importance of the oxidation step, particularly by acid treatment of the substrate.

After the clogging step, the metal substrate may be dried with no prior rinsing or after a cold rinsing.

A clogging time period of 30 minutes is sufficient, but an extension of the immersion time does not adversely affect the aspect of the deposit.

D/Influence of the Phosphor Size

This series of manipulations aims at confirming the influence of the particle size on the marker integration during the clogging step.

The europium-doped yttrium vanadate micrometer-range particles are commercial particles (Phosphor Technology QHK 63/ FF-U1) with no specific shape and having an average 2-micrometer size.

Counterexamples 4 to 6 concern the use of such micrometer-range particles.

The particle concentrations are 1 g/L, the solvent is water, and the temperature of the clogging bath is 99° C.

For each of the examples of table 5, one of the two strips is rinsed with distilled water just after coming out of the clogging bath and before being dried (AR), the other being simply left to dry in the ambient air (SR).

TABLE 5
Influence of the phosphor size

| | | Immersion | | |
|---|---|---|---|---|
| Example | Particles | time | Luminescence | Observations |
| Example 10 | Non-coated nanoparticles | 10 minutes | AR: no | |
| | | | SR: no | |
| Counter- | Non-coated micrometer-range | 10 minutes | AR: no | SR: Luminescent even on the |
| example 4 | particles | | SR: yes, but non- | areas with no acid treatment |
| | | | local | under UV illumination. Under |
| | | | | a visible illumination, |
| | | | | presence of a white veil. |
| Example 12 | Non-coated nanoparticles | 30 minutes | AR: no | |
| | | | SR: no | |
| Counter- | Non-coated micrometer-range | 30 minutes | AR: light | SR: Luminescent even on the |
| example 5 | particles | | SR: yes, but non- | areas with no acid treatment |
| | | | local | under UV illumination. Under |
| | | | | a visible illumination, |
| | | | | presence of a white veil. |
| Example 14 | Non-coated nanoparticles | 60 minutes | AR: no | |
| | | | SR: light | |
| Counter- | Non-coated micrometer-range | 60 minutes | AR: light | SR: Luminescent even on the |
| example 6 | particles | | SR: yes, but non- | areas with no acid treatment |
| | | | local | under UV illumination. Under |
| | | | | a visible illumination, |
| | | | | presence of a white veil. |

The micrometer-range particle dispersion is prepared by addition of glass balls having a 4-mm diameter in a mixture under stirring of micrometer-range particles in water. After 24 hours of stirring, the suspension is white and the particles settle rapidly if a stirring is not maintained in the clogging vial.

The glass balls enable to perform an attrition by shearing of the micrometer-range particles and thus promote their suspension in the aqueous phase by deagglomeration of the powder grains, without for all this modifying the size of the unit particles.

A light white veil appears after drying on the strips treated with micrometer-range particles. The marking is not “invisible” to the eye, conversely to examples concerning the use of particles having an average size smaller than 1,000 nanometers.

Thus, the size of the luminescent marker having an average size smaller than 1,000 nanometers is in accordance with the porosity sizes of the passivation layer of the metal substrate. Indeed, a micrometer-range marker remains at the substrate surface and may be only partially or not trapped during the step of clogging the porosity.

Of course, the present invention is likely to have various alterations, modifications, and improvements which will readily occur to those skilled in the art. Such alterations, modifications, and improvements are intended to be part of this disclosure, and are intended to be within the spirit and the scope of the present invention. Accordingly, the foregoing description is by way of example only and is not intended to be limiting. The present invention is limited only as defined in the following claims and the equivalents thereto.

1. A method of marking a metal substrate comprising the steps of:
forming a passivation layer by oxidation of the surface of the metal substrate;
incorporating inorganic luminescent particles within the metal substrate passivation layer, the average particle size being in the range from 4 to 1,000 nm; and
clogging the passivation layer.

2. The method of marking a metal substrate of claim 1, wherein said metal substrate is a material selected from the group consisting of stainless steels; tin; zinc; titanium; aluminum and wrought or casting alloys thereof; and mixtures thereof.

3. The method of marking a metal substrate of claim 1, wherein the inorganic luminescent particles are selected from the group consisting of particles based on metal oxide; metal sesquioxide; metal oxyfluoride; metal vanadate; metal fluoride; and mixtures thereof.

4. The method of marking a metal substrate of claim 3, wherein the inorganic luminescent particles are selected from the group consisting of particles of Y₂O₃; YVO₄; Gd₂O₃; Gd₂O₂S; LaF₃; and mixtures thereof.

5. The method of marking a metal substrate of claim 1, wherein the inorganic luminescent particles are doped with one or a plurality of active sites from the lanthanide family or from the family of transition elements.

6. The method of marking a metal substrate of claim 1, wherein the particles are doped with ions from the lanthanide family.

7. The method of marking a metal substrate of claim 1, wherein the particles are encapsulated.

8. The method of marking a metal substrate of claim 1, wherein the particle incorporation is performed by dipping of the metal substrate into a colloidal suspension.

9. The method of marking a metal substrate of claim 8, wherein the metal substrate is dipped for a time period in the range from 5 to 120 minutes into the colloidal suspension of said inorganic luminescent particles.

10. The method of marking a metal substrate of claim 8, wherein the colloidal suspension is at a temperature in the range from 90 to 100° C.

11. The method of marking a metal substrate of claim 1, wherein the step of clogging the passivation layer is performed simultaneously to the incorporation of the inorganic luminescent particles.

12. The method of marking a metal substrate of claim 8, wherein the colloidal suspension has a particle concentration in the range from 0.01 to 10 g/L.

13. The method of marking a metal substrate of claim 1, wherein the particles are nanoparticles having an average size in the range from 4 to 100 nanometers.

14. A metal substrate obtained according to the method of claim 1.

15. The method of marking a metal substrate of claim 6, wherein the particles are doped with ions of europium.

16. The method of marking a metal substrate of claim 7, wherein the particles are encapsulated in polysiloxane or silicon oxide.

17. The method of marking a metal substrate of claim 9, wherein the metal substrate is dipped for a time period in the range from 10 to 60 minutes.

18. The method of marking a metal substrate of claim 13, wherein the particles are nanoparticles having an average size in the range from 20 to 50 nanometers.
